(19) United States
(12) Patent Application Publication
(10) Pub. No.: US 2026/0205054 A1
(43) Pub. Date: Jul. 16, 2026

(54) SOLAR PANEL MODULE FRAME CORNER JOINING COMPONENTS

(71) Applicant: Nextpower LLC, Fremont, CA (US)

(72) Inventors: Alexander W. Au, Oakland, CA (US); Madeleine Davis Kho, Oakland, CA (US); Ricardo Delgado-Nanez, San Jose, CA (US); Ryan Patel, Pleasanton, CA (US); Ning Liu, Folsom, CA (US)

(21) Appl. No.: 19/445,808

(22) Filed: Jan. 12, 2026

Related U.S. Application Data
(60) Provisional application No. 63/745,299, filed on Jan. 14, 2025.

(51) Int. Cl. H02S 30/10; F16M 13/02

(52) U.S. Cl. CPC H02S 30/10; F16M 13/02

(57) ABSTRACT

Some embodiments include a solar module assembly with a solar module, short edges, long edges, and corner tabs, where at least one of the short edges and the long edges include the corner tabs. Some embodiments include a solar module assembly with a solar module, short edges including a first plurality of protrusions, long edges including a second plurality of protrusions, and corner joints including a plurality of openings, where the plurality of openings lock with the first plurality of protrusions and the second plurality of protrusions. Some embodiments include a method of forming a solar module assembly, the method including preparing joining components of a solar module frame, positioning the edges and solar module for assembly, applying sealant to one or more of the edges, and assembling the edges and the solar module into the solar module assembly.

### RELATED APPLICATIONS

This application claims the benefit of U.S. Provisional Patent Application No. 63/745,299, filed Jan. 14, 2025, the entire contents of which are incorporated herein by reference.

### FIELD

This disclosure relates generally to solar tracking systems and solar modules, and more particularly to corner joining components of solar module frames within solar tracking systems.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

A conventional solar tracking system includes a plurality of components assembled and installed on-site in the field at the location where the solar tracking system is to operate. Examples of on-site installation can include installing rails at a torque tube for supporting one or more solar modules at the torque tube, installing solar modules at the installed rails at the torque tube, etc. While some components of the solar tracking system are assembled and installed on-site, other components can be pre-assembled prior to arriving on site. For example, fabrication factories can be utilized to create various materials/components and installation factories can be utilized to assemble the materials/components to form a larger component/assembly. In some instances, these pre-assembled components can be shipped and/or transported to the on-site location. An example of a component that can be pre-assembled is a solar module.

Conventional solar modules can include an aluminum solar module frame to protect and support the solar module. During the assembly process of the solar module frame, the sides/edges of the frame can be connected through a machine applying pressure to the edges to push them together. However, a large amount of pressure can be used/needed to connect the edges which can cause the solar module frames to break. Additionally, the manufacturing process of the aluminum solar module frame/edges can have a large carbon footprint, in some instances.

### SUMMARY

In general, this disclosure is directed to solar tracking systems and solar modules and, more particularly, to corner joining components of solar module frames within solar tracking systems. In one example, the present disclosure includes a solar module assembly. The solar module assembly can include a solar module. The solar module assembly can also include short edges. The solar module assembly can also include long edges. The solar module assembly can also include corner tabs, where at least one of the short edges and the long edges include the corner tabs.

In another example, the present disclosure includes a solar module assembly. The solar module assembly can include a solar module. The solar module can also include short edges including a first plurality of protrusions. The solar module can also include long edges including a second plurality of protrusions. The solar module can also include corner joints including a plurality of openings, where the plurality of openings lock with the first plurality of protrusions and the second plurality of protrusions.

In another example, the present disclosure includes a method of forming a solar module assembly. The method can include preparing joining components of a solar module frame, resulting in one or more of long edges and short edges including the joining components, where the joining components include at least one of corner tabs and corner joints. The method can also include positioning the long edges, the short edges, and a solar module for assembly. The method can also include applying sealant to one or more of the long edges and the short edges. The method can also include assembling the long edges, the short edges, and the solar module into the solar module assembly.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present invention and, therefore, do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a schematic, perspective view of a solar tracker apparatus, according to an embodiment.

FIG. 2 is a perspective view of a solar module assembly with corner tabs, according to an embodiment.

FIG. 3 is a perspective view of the components of the solar module assembly shown in FIG. 2, according to an embodiment.

FIG. 4 is a perspective view of an edge with tabs for the solar module assembly shown in FIG. 2, according to an embodiment.

FIG. 5 is a perspective view of a joined corner of a solar module frame of the solar module assembly shown in FIG. 2, according to an embodiment.

FIG. 6 is a perspective view of an example joined corner with an inside tab, according to an embodiment.

FIG. 7 is a perspective view of an example joined corner with an outside tab, according to an embodiment.

FIG. 8 is a perspective view of an example joined corner of a solar module frame, according to an embodiment.

FIG. 9 is a perspective view of an example cross-section of an edge of a solar module frame, according to an embodiment.

FIG. 10 is a perspective view of an example cross-section of an edge of a solar module frame, according to an embodiment.

FIG. 11 is a perspective view of an example edge type, according to an embodiment.

FIG. 12 is a perspective view of an example joined corner with the edge type depicted in FIG. 11, according to an embodiment.

FIG. 13 is a perspective view of an example joined corner with a sidewall clinching point, according to an embodiment.

FIG. 14 is a perspective view of an edge of the joined corner of FIG. 13, according to an embodiment.

FIG. 15 is a perspective view of an example joined corner with a bottom clinching point, according to an embodiment.

FIG. 16 is a perspective view of an edge of the joined corner of FIG. 15, according to an embodiment.

FIG. 17 is a perspective view of a solar module assembly with corner joints, according to an embodiment.

FIG. 18 is a perspective view of the components of the solar module assembly shown in FIG. 17, according to an embodiment.

FIG. 19A-19C are a variety of perspective views of an example corner joint, according to an embodiment.

FIG. 20 is a perspective view of an edge of a solar module frame, according to an embodiment.

FIG. 21 is a perspective view of a corner of a solar module frame prior to joining, according to an embodiment.

FIG. 22 is a perspective view of the corner of the solar module frame shown in FIG. 8 after joining, according to an embodiment.

FIG. 23A-23B are a variety of perspective views of an example corner joint, according to an embodiment.

FIG. 24A-24D are a variety of perspective views of an example corner joint, according to an embodiment.

FIG. 25A is a of perspective view of a joined corner with the corner joint depicted in FIG. 24A-24D , according to an embodiment.

FIG. 25B is a perspective view of a cross-section of the joined corner of FIG. 25A, according to an embodiment.

FIG. 26 is a flow diagram of an exemplary method of assembling a solar module assembly with corner joining components, according to an embodiment.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

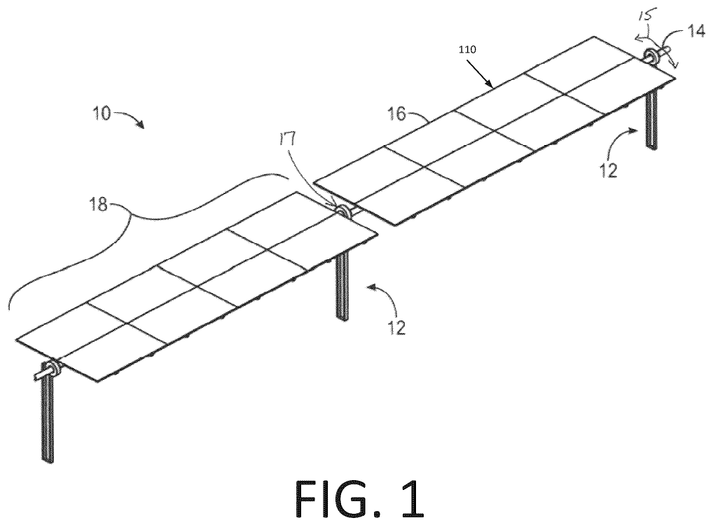

FIG. 1 illustrates an embodiment of a solar tracker apparatus 10. The solar tracker apparatus 10 can include a plurality of piers 12 disposed in spaced relation to one another and embedded in the ground. The solar tracker apparatus 10 can include one or more torque tubes 14 that can extend between adjacent piers 12 and can be rotatably supported at each pier 12. The solar tracker apparatus 10 can further include a plurality of solar modules 16 (e.g., solar panels having photovoltaic cells, such as a photovoltaic laminate with a plurality of photovoltaic cells) supported at the respective torque tube 14. The one or more torque tubes 14 can be rotated in directions 15 so as to change an angle of the solar modules 16, such as throughout a day as the location of the sun changes relative to the solar modules 16. A bearing housing assembly 17 can be configured to rotatably connect torque tubes 14 along a span of the solar tracker apparatus 10. The span between two adjacent piers 12 can be referred to as a bay 18 and, for example, each bay 18 can be rotatably connected to an adjacent bay 18 via the bearing housing assembly 17. A plurality of solar tracker apparatus 10 rows may be arranged in a north-south longitudinal orientation to form a solar array.

Each solar module 16 can include a solar module frame 110 that is coupled to the torque tube 14. The combination of the solar module 16 and the solar module frame 110 can be referred to herein as a solar module assembly. In some instances, the solar module frame 110 can be directly coupled to the torque tube 14 (e.g., for embodiments of the solar module frame 110 that include an integrated rail component) and in other instances the solar module frame 110 can be indirectly coupled to the torque tube 14 by coupling the solar module frame 110 directly to a rail and coupling that rail to the torque tube 14. In various embodiments, adjacent solar module frames 110 of adjacent solar modules 16 can be coupled together.

The following disclosure will describe various solar module frame embodiments that can be used, for instance, in a solar tracker apparatus. Such embodiments disclosed herein can, for example, be useful in facilitating effective frames (e.g., maintaining strength and durability) that can be more cost effective; frames with a stronger connection/joining between edges of the frame; frames that utilize material(s) that can reduce the carbon footprint (compared to conventional materials such as aluminum); frame pieces that can effectively be joined at the corners of the frame with minimal and/or no additional hardware; more tailored/customizable frames with different edge geometries in the same frame; and/or frames with a lower cost and/or less material. The illustrated embodiments are examples of inventive concepts disclosed herein and as such it should be noted that features of various illustrated solar module assemblies and/or solar module frames can be intermixed and combined for certain applications within the scope of this disclosure.

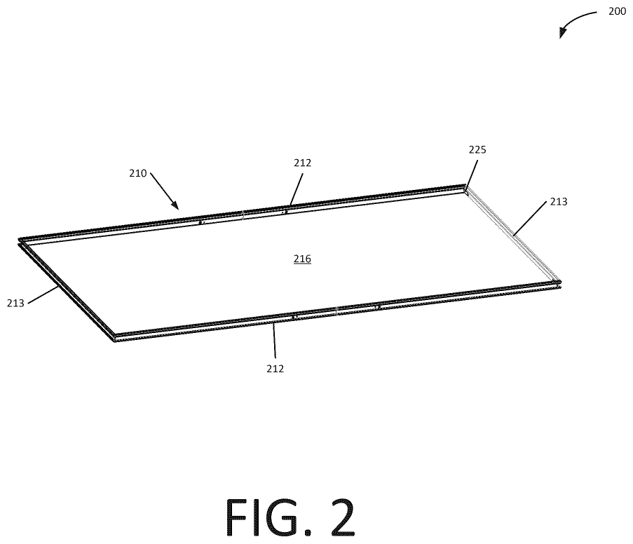

FIG. 2 illustrates a perspective view of an embodiment of a solar module assembly 200 with corner joining components (in this instance, corner tabs). Solar module assembly 200 can include a solar module 216 and a solar module frame 210. In some embodiments, solar module 216 can be the same/similar as solar module 16 (FIG. 1) and/or solar module frame 210 can be the same/similar as solar module frame 110 (FIG. 1). In some instances, a solar module assembly 200 can be made up of a plurality of components that are assembled together (for example, in a factory such as an installation factory).

Corner joining components, as referred to herein, refers to components of the solar module frame 210 that are used to join together various edges (e.g., long edges and short edges) of the solar module frame 210. In some instances, the corner joining components are a part of (i.e., a singular piece with) one or more of the edges of the solar module frame 210. In some instances, the corner joining components are components that are separate but connected to one or more of the edges of the solar module frame. Corner joining components can also be referred to herein as simply joining components.

As depicted in FIG. 2, solar module frame 210 can include joining components (225). These corner joining components can help join the solar module frame edges (212, 213) without breaking the frame. The corner joining components depicted in FIG. 2 are corner tabs 225, also referred to simply as tabs 225. These tabs 225 can be a part of the frame edges such that the frame edge and the tab 225 are a singular piece. Therefore, tabs 225 can be a joining component that requires no additional hardware to join together edges 212, 213 of the frame.

In some embodiments, solar module frame 210 includes two short edges 213 and two long edges 212. Edges, as referred to herein, refers to the side components of the solar module frame 210. In some instances, while the frame 210 edges are referred to herein as long and short edges, the short edges 213 can be lateral edges/portions of the solar module frame 210 and the long edges 212 can be the longitudinal edges/portions of the solar module frame 210, regardless of size. Lateral and longitudinal can, in some embodiments, refer to the positioning of the edges 212, 213 when the solar module assembly 200 is coupled to the torque tube 14 and a part of the solar tracker apparatus 10.

In some instances, as discussed herein, one or more of the edges 212, 213 can include tabs 225. In some embodiments, as depicted in FIG. 2, the long edges 212 can include tabs 225 and the short edges may not include tabs 225. In some embodiments, the short edges 213 can include tabs 225 and the long edges 212 may not include tabs 225. As will be discussed further herein, the tabs 225 can be clinched together with the edges (for example, the tabs 225 that are a part of edges 212 can be clinched with edges 213) in order to join together edges 212 and 213. In some instances, utilizing tabs 225 and clinching can reduce the likelihood of the solar module frame 210 and/or the solar module assembly 200 breaking during the formation/assembly process of the frame 210. For instance, when using tabs 225, the tabs 225 and the edges 212, 213 may simply be placed together and then clinched, instead of forcing edges/components together with pressure (as can occur in conventional methods) which can risk breakage.

In some embodiments, solar module frame 210 is a steel frame. A steel frame can be a more cost effective material/frame without sacrificing strength and durability (i.e., maintaining strength and durability of the frame 210). Further, in some instances, utilizing steel frames can reduce the carbon footprint during manufacturing/production of the frame components, as the production of steel frame components can have smaller carbon footprint than that of aluminum frame components.

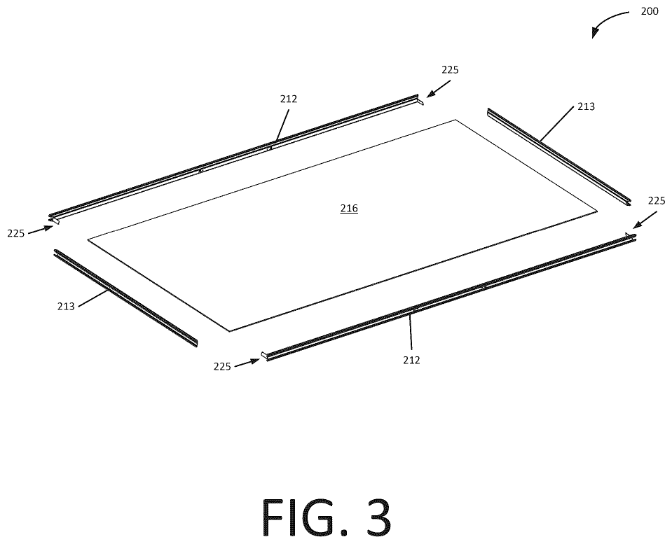

FIG. 3 illustrates the components of the solar module assembly 200 shown in FIG. 2, according to an embodiment. As discussed herein, solar module assembly 200 can include a solar module 216 and a solar module frame 210 (depicted in FIG. 2). The solar module frame 210 can include long edges 212 and short edges 213. In solar module assembly 200, the long edges 212 can include tabs 225 that can be used as joining components to join together edges 212 and 213, thus forming a solar module frame 210. Although FIG. 3 depicts long edges 212 as having tabs 225, in some instances short edges 213 may have tabs 225 and long edges 212 may not have tabs 225.

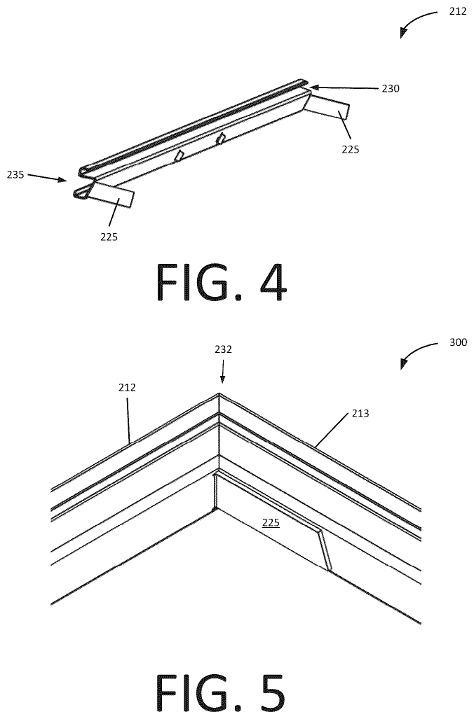

As illustrated in FIG. 4, long edge 212 can have tabs 225 that are bent (for example, at an angle the same or similar to 90 degrees. In some embodiments, the edge 212 is manufactured with un-bent tabs 225 (for example, at a manufacturing and/or fabrication factory) and the tabs 225 are bent prior to the assembly of the frame 210. The bending process may be referred to herein as a pre-bend, as the tabs 225 are pre-bent prior to assembly. In some embodiments, the tabs 225 are bent at an installation factory (e.g., a factory/plant where the solar module frame 210 is assembled/installed).

In some embodiments, as depicted in FIG. 4, an edge (such as long edge 212) includes a solar module receptacle 230 portion of the edge 212 and a base 235 portion of the edge 212. The solar module receptacle 230 is the portion of the edge 212 that holds/contains the solar module 216. The base 235 is the portion of the edge 212 that provides a base and/or support for the frame 210 and/or the solar module 216. In some embodiments, as depicted in FIG. 4, the tabs 225 can be a part of the base 235 portion of the edge 212.

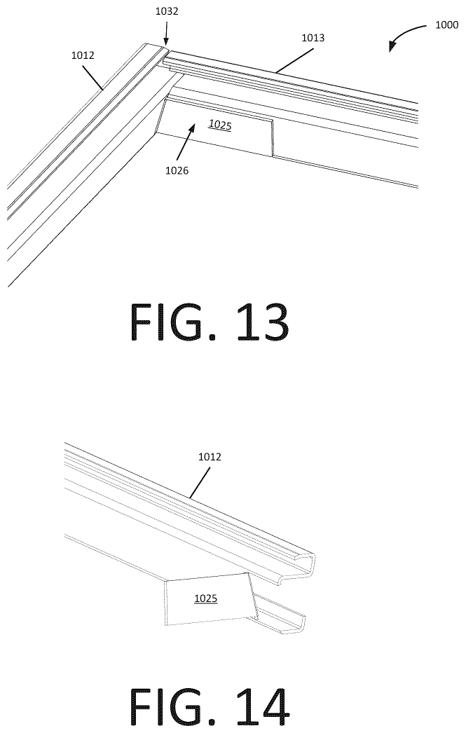

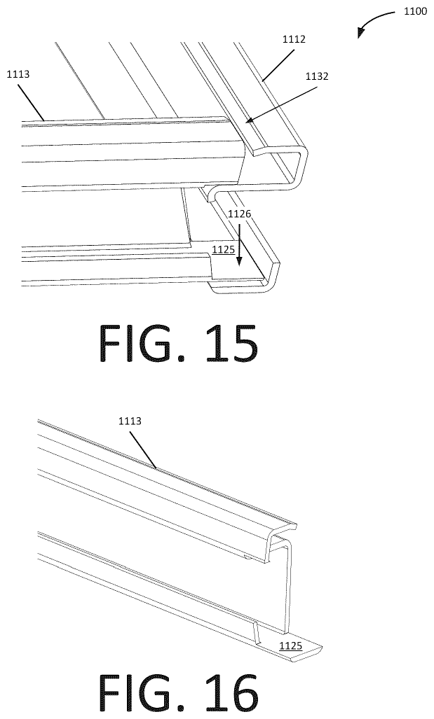

FIG. 5 illustrates a joined corner 300 of a solar module frame (210) of the solar module assembly (200) shown in FIG. 2, according to an embodiment. As discussed herein, edges 212 and 213 of a solar module frame 210 can be joined using a tab 225. For instance, long edge 212 can include a tab 225, and this tab can be cliched with short edge 213 to join the edges 212 and 213. Joining, as referred to herein, is the connecting, fusing, attaching, etc. of components (in this instance, edges 212, 213). As depicted in FIG. 5, joined corner 300 has a joint geometry 232 where edges 212 and 213 are flush against each other. This can be achieved by edges 212 and 213 having ends with 45-degree angles, such that the edges 212, 213 can meet and achieve a 90-degree angle. Although joined corner 300 is depicted with a joint geometry 232, joined corner 300 can have other joint geometries (for example, as depicted in FIG. 5, FIG. 12, FIG. 13, FIG. 15, etc.).

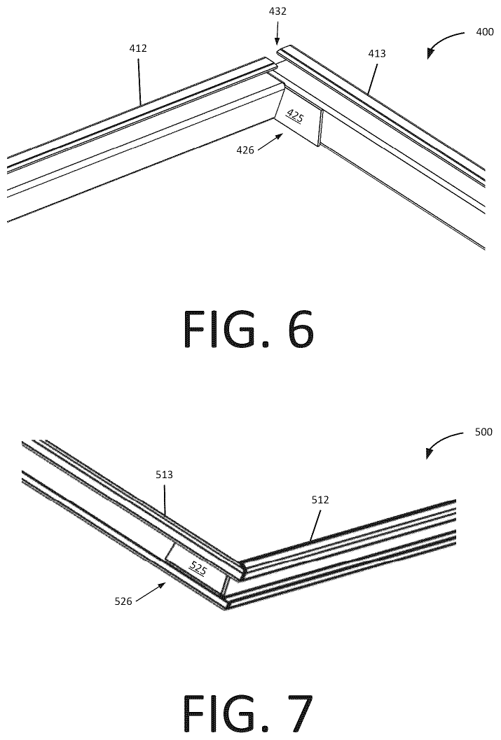

As depicted in FIG. 6 (and also depicted in FIGS. 2-5), a joined corner (such as joined corner 400) can include a tab 425 that is clinched to an inside region of the short edge 413. Inside, as referred to herein, refers to the portions of the edges 412, 413 that will be in an inside/inner region of the solar module frame (e.g., solar module frame 210). Outside, as referred to herein, refers to the portions of the edges 412, 413 that will be in an outside/outer region of the solar module frame (e.g., solar module frame 210).

In some instances, when a tab is being clinched to an inside region of the short edge 413 (as depicted in FIG. 6), tab 425 can have a clinching point 426. Clinching point 426 can show the area and direction, in some instances, where tab 425 is clinched to short edge 413. In some embodiments, although a single clinching point 426 is depicted, joined corner 400 can have any number of clinching points 426. Clinching uses a punch and a die to join together the tab 425 and the side 413. In an example where there are multiple clinching points 426, multiple punching points can be integrated into a single die and a single punch. For example, a single die and a single punch could have three punching points, which would result in three clinching points (e.g., three points/spots where tab 425 is clinched to short side 413). Having the ability to have multiple clinching points 426 can increase the connection/joining (have a stronger connection) between edges 412 and 413 due to the multiple clinching points 426.

As depicted in FIG. 6, joined corner 400 includes joint geometry 432. In this exemplary instance, both edges 412 and 413 can have straight ends (compared to the 45-degree ends depicted in FIGS. 5 and 7. Joint geometry 432 includes placing an end of edge 413 against edge 413 such that a corner is formed.

FIG. 7 illustrates an example joined corner 500 of a solar module frame (e.g., similar to solar module frame 210). In joined corner 500, tab 525 is clinched to an outside region of the short edge 513. In some instances, an outside tab 525 can have one or more clinching points 526.

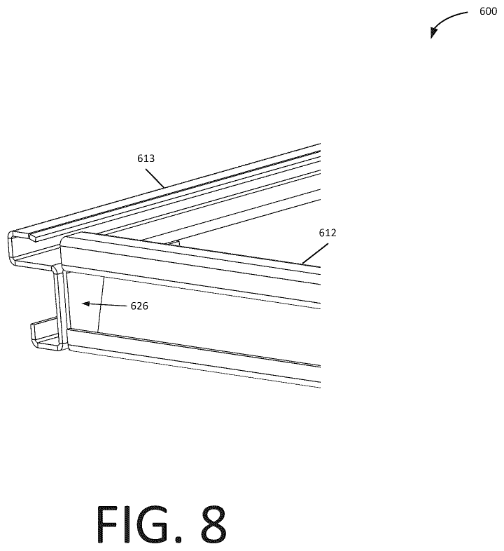

FIG. 8 illustrates another exemplary joined corner 600 of a solar module frame (such as solar module frame 210). In some instances, as depicted in FIG. 8, when joining together long edge 612 and short edge 613, one or more clinching points such as clinching point 626 can be used. Clinching point 626 can clinch the edges 612, 613 through an outside region of the base portion of edge 612, in some instances. As discussed herein, although a single clinching point 626 is depicted, clinching point 626 can include any number of clinching points.

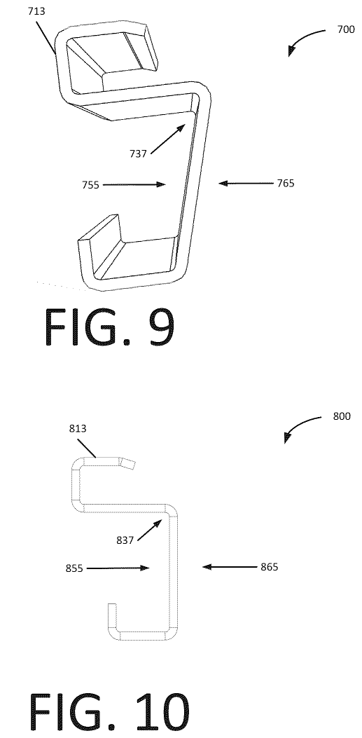

In some embodiments, a solar module frame (such as solar module frame 200) can include different edge types (i.e., edges with different structures, designs, profiles, etc.). FIG. 9 depicts a cross-section of an exemplary profile geometry 700 of an edge 713. Although a short edge 713 is depicted, a long edge could have a profile geometry 700. Profile geometry 800 includes an acute angle 737. This angle 737 can help form a joint geometry such as joint geometry 232 (FIG. 5), in some instances. Edge 713 can include an inside region 765 and an outside region 755. The inside region 765 is in an inner portion of the solar module frame and the outside region 755 is in an outer portion of the solar module frame. In some embodiments, as discussed herein, a tab could be clinched to either the inside region 765 or the outside region 755 of the short edge 713.

FIG. 10 depicts a cross-section of an exemplary profile geometry 800 of an edge 813. Although a short edge 813 is depicted, a long edge could have profile geometry 800. Profile geometry 800 can include an angle 837 the same as or similar to a right angle (i.e., 90-degrees). This angle 837 can help form a joint geometry such as joint geometry 432 (FIG. 6), in some instances. Edge 813 can include an inside region 865 and an outside region 855. In some embodiments, as discussed herein, a tab could be clinched to either the inside region 865 or the outside region 855 of the short edge 813.

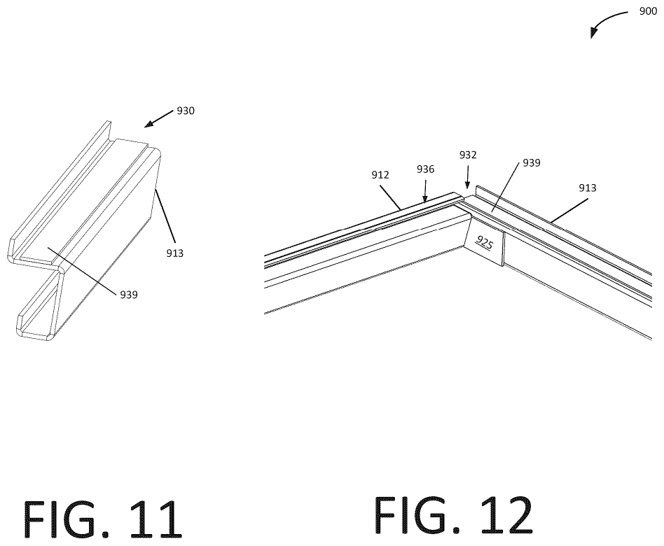

FIG. 11 illustrates an example edge type of an edge within a solar module frame (such as solar module frame 210). While FIG. 11 depicts a short edge 913, a long edge could have an edge type the same as or similar to what is depicted in FIG. 11. As depicted in FIG. 11, short edge 913 is a lipless short edge and does not include a lip in the solar module receptacle 930 region/portion of the short edge 913. FIG. 4 depicts an exemplary solar module receptacle 230 with a lip, in some embodiments. A lip can be used to help secure/contain a solar module (such as solar module 216) in/on a solar module frame (such as solar module frame 210). On a lipless short edge such as short edge 913, the solar module can be secured to the short edge 913 using an adhesive 939. In some embodiments, adhesive 939 is double sided adhesive tape. A lipless short edge 913 can have numerous advantages including preventing soil from building up on/in the lip (as lipless short edge 913 does not include a lip in the solar module receptacle 930), facilitating snow shedding (i.e., allowing snow to shed and/or slide off the solar module assembly instead of being stuck/trapped (for example, by the frame lip)), and reducing material cost (as material for the frame lip would no longer be needed).

FIG. 12 illustrates an example joined corner 900 with the lipless short edge 913. While joined corner 900 is an example joined corner with a lipless short edge 913, other types of joined corners may include a lipless short edge 913. For example, a joined corner may have a lipless short edge 913 and a lipless long edge, a joined corner may include a lipless short edge 913 and a different type of long edge, etc. Joined corner 900 is joined through a tab 925. FIG. 12 depicts tab 925 as being part of a long edge 912 and being clinched to a short edge 913, however tab 925 may be a part of a short edge 913 and clinched to a long edge 912, in some instances.

As depicted in FIG. 12, example joined corner 900 includes a long edge 912 with a lip 936 and a lipless short edge 913. The lip 936 can help secure the solar module on the long edge(s) 912 and the adhesive 939 can help secure the solar module on the short edge(s) 913. As discussed herein, and depicted in FIG. 12, a solar module frame can include different types of edges. FIG. 12 depicts a joined corner 900 of a solar module frame with a first edge type (e.g., an edge with a lip) for the long edge(s) 912 and a second edge type (e.g., a lipless edge) for the short edge(s) 913. Other examples of different edge types include edges with different edge profiles (such as an edge with profile 700 (FIG. 9) and an edge with profile 800 (FIG. 10)). A solar module frame with a plurality of different edge types (for example, short edges 913 with a first edge type and long edges 912 with a second edge type) can allow for a more customized and optimized solar module frame. For example, the edge types can be optimized to help meet the strength requirement of the frame and each component (e.g., edge 912, 913) of the frame. A solar module frame with different edge types can also have a reduced cost (compared to conventional solar module frames), as some edge types can require less material than other edge types, thus resulting in less overall material for the solar module frame and therefore a reduction in cost. Further, no extra joints or components are needed, as the tab(s) 925 can join/connect the edges 912, 913, also reducing the cost of the solar module frame.

FIG. 13 illustrates an example joined corner 1000. Joined corner 1000 has an example joint geometry 1032. In joint geometry 1032, portions of long edge 1012 and short edge 1013 may overlap/intersect in order to form a corner. In some embodiments, as depicted in FIG. 13, long edge 1012 and short edge 1013 can have different edge types and/or profile geometries. Joined corner 1000 includes a tab 1025 that is joined/clinched with short edge 1013 along the sidewall of short edge 1013. Put differently, tab 1025 is a sidewall tab and has a sidewall clinching point 1026. Although a single sidewall clinching point 1026 is depicted, joined corner 1000 can include any number of clinching points.

FIG. 14 illustrates the long edge 1012 of the joined corner 1000. Long edge 1012 can include a tab 1025 that is pre-bent prior to assembling the solar module frame. In some instances, as depicted in FIG. 14, bending the tab 1025 can result in a cutout/opening in the long edge 1012. This can help create the joint geometry 1032, in some instances.

FIG. 15 illustrates an example joined corner 1100. Joined corner 1000 has an example joint geometry 1132. In joint geometry 1132, portions of long edge 1112 and short edge 1113 may overlap/intersect in order to form a corner. In some embodiments, as depicted in FIG. 15, long edge 1112 and short edge 1113 can have different edge types and/or profile geometries. In joined corner 1100, the short edge 1113 can have the tab 1125 that is clinched/joined with the long edge 1112. In some embodiments, as illustrated in FIG. 15, the tab 1125 may be along a bottom portion of the edge 1113 and can be joined/clinched with the long edge 1112 along the bottom of the long edge 1112. Put differently, tab 1125 is a bottom tab and has a bottom clinching point 1126. Although a single sidewall clinching point 1126 is depicted, joined corner 1100 can include any number of clinching points. FIG. 16 illustrates an example edge (in this instance, short edge 1113) with a bottom tab 1125. Having edges with different clinching point areas (e.g., bottom clinching point 1126 and/or sidewall clinching point 1026) can improve the connection/joining between edges (i.e., have a stronger connection) because of the ability for different clinching points and/or areas.

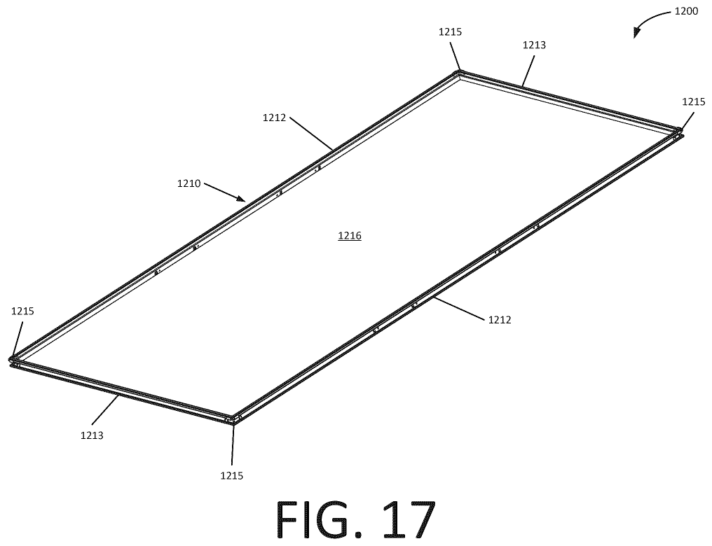

FIG. 17 illustrates a solar module assembly 1200 with corner joining components (in this instance, corner joints). Solar module assembly 1200 can include a solar module 1216 and a solar module frame 1210. In some embodiments, solar module 1216 can be the same/similar as solar module 16 (FIG. 1) and/or solar module frame 1210 can be the same/similar as solar module frame 110 (FIG. 1). In some instances, solar module assembly 1200 can be made up of a plurality of components that are assembled together (for example, in a factory such as an installation factory). Solar module frame 1210 (and its components such as the edges 1212, 1213 and corner joints 1215) can be steel, in some embodiments, to increase the strength and durability of the frame 1210.

As discussed herein, corner joining components can refer to components of the solar module frame 1210 that are used to join together various edges (e.g., long edges and short edges) of the solar module frame 1210. In some instances (for example, in instances where the corner joining components are tabs), the corner joining components are a part of (i.e., a singular piece with) one or more of the edges of the solar module frame. In some instances, as depicted in FIGS. 2 and 3, the corner joining components are components that are separate but connected to one or more of the edges of the solar module frame.

In solar module assembly 1200, the corner joining components can be corner joints 1215 (also referred to herein as simply joints 1215). Corner joints 1215 can help join/connect the solar module frame edges (1212, 1213) with minimal additional hardware (as only the corner joints 1215 and the edges 1212, 1213 are needed).

In some embodiments, solar module frame 1210 includes two short edges 1213 and two long edges 1212. Edges, as referred to herein, refers to the side components of the solar module frame 1210. In some instances, while the frame 1210 edges are referred to herein as long and short edges, the short edges 1213 can be lateral edges/portions of the solar module frame 1210 and the long edges 1212 can be the longitudinal edges/portions of the solar module frame 1210, regardless of size.

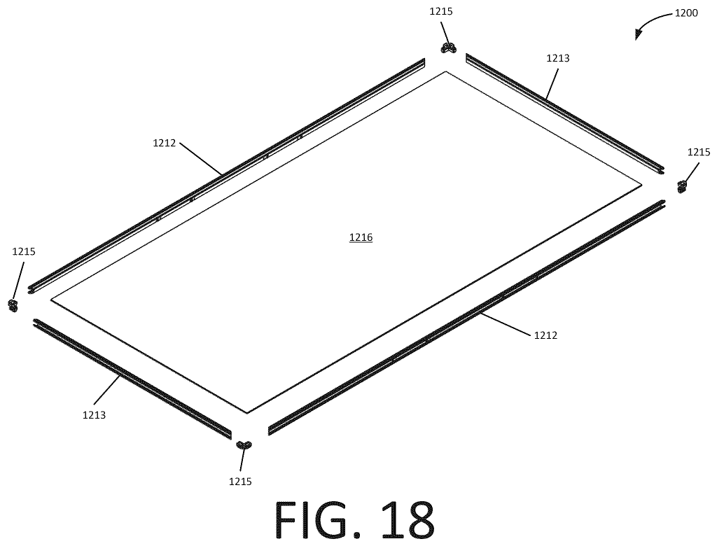

FIG. 18 illustrates a perspective view of the components of the solar module assembly 1200 shown in FIG. 17. As discussed herein, solar module assembly 1200 can include short edges 1213 and long edges 1212 that are joined together using corner joints 1215. These edges 1212, 1213 and corner joints 1215 can be formed/assembled around solar module 1216 to form solar module assembly 1200. As depicted in FIG. 18, corner joints 1215 may be separate components from long edges 1212 and short edges 1213 but may connect to both long edges 1212 and short edges 1213 and may be used to join them.

In some instances, corner joints 1215 can increase the stability of the solar module frame 1210 and can help form the frame 1210 with less risk of breaking the frames. By utilizing corner joints 1215, cost can be minimized, as geometry of the corner joints 1215 can be designed to match existing frame member profiles, thus new framing equipment does not need to be acquired. Further, corner joints 1215 can be designed to be fabricated through different manufacturing processes (such as stamping, forming, and/or casting) to optimize cost and ease assembly requirements.

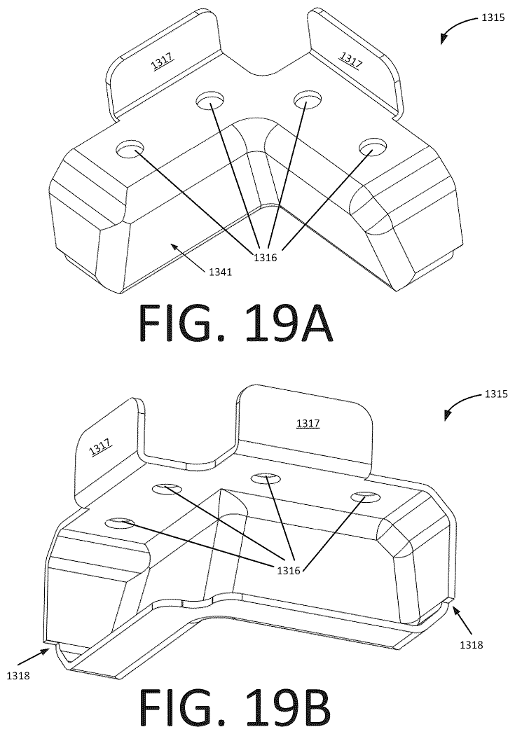

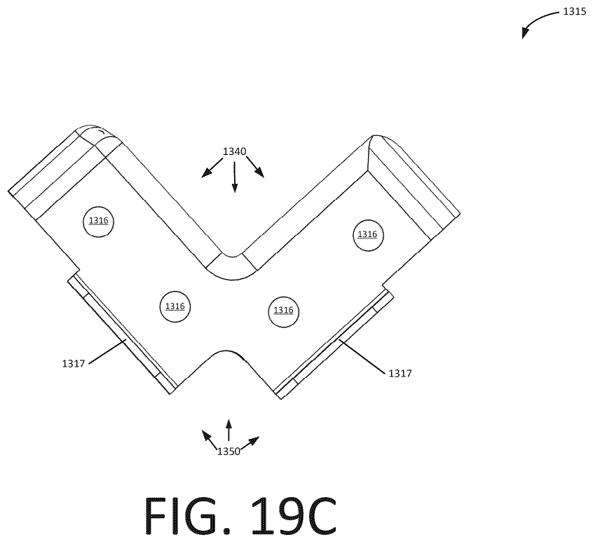

FIG. 19A-19C illustrate various perspective views of an example corner joint 1315. Corner joint 1315 is an example corner joining component used to join together edges (e.g., long edges 1212 and short edges 1213) of a solar module frame (e.g., solar module frame 1210). In some embodiments, corner joint 1315 is the same/similar as corner joint 1215 (FIGS. 17-18). Corner joint 1315 can help effectively join together/form components of a solar module frame without breaking the frame.

In some embodiments, corner joint 1315 includes openings 1316. These openings 1316 can serve as locator and locking holes that help guide/position the edges of the frame (e.g., long edges 1212 and short edges 1213) to their proper location and lock the edges into position. This can help form the frame without unnecessary excessive force (which can cause breakage) and can effectively join the edges 1212 and 1213 (for example, through the locking). In some instances, as discussed further herein, the edges of the solar module frame can include protrusions that lock into the openings 1316. As depicted in FIG. 19A, corner joint 1315 can include four openings 1316, in some instances. In these instances, two openings 1316 may serve as the locator/locking mechanism for a short edge of the solar module frame and two openings 1316 may serve as the locator/locking mechanism for a long edge of the solar module frame.

In some embodiments, corner joint 1315 includes stoppers 1317. Stoppers 1317 can extend from a top surface of the corner joint 1315 and can help position/guide the frame edges 1312, 1313 and stop them from moving beyond the corner joint 1315. Although corner joint 1315 is depicted with stoppers 1317, there are instances where stoppers 1317 may not be needed and the openings 1316 may be effective locators/guides for the long and short edges. Thus, there may be instances where corner joint 1315 does not include stoppers 1317.

In some instances, as depicted in FIG. 19A, corner joint 1315 can include support 1341 in an inside portion of the corner joint 1315. Inside, as referred to herein, refers to the portions of the corner joint 1315 and/or the edges that will be in an inside/inner region of the solar module frame. Outside, as referred to herein, refers to the portions of the corner joint 1315 and/or the edges that will be in an outside/outer region of the solar module frame. FIG. 19C depicts the inside region 1340 of the corner joint 1315 and the outside region 1350 of the corner joint 1315. The support 1341 of corner joint 1315 may be in an inside region 1340 and the stoppers 1317 may be in an outside region 1350, in some instances.

As depicted in FIG. 19B, corner joint 1315 can include frame edge recess 1318. In some instances, frame edge recess 1318 can be in an outside region 1350 of the corner joint 1315. Frame edge recess 1318 can be a recess/opening in the corner joint 1315 that creates space for (and in some instances, can rest on top of) an edge of a frame (e.g., edge(s) 1212 and/or 1213).

In some embodiments, a solar module frame can include four corner joints 1315 (for example, the same/similar as what is depicted in FIG. 17). Each corner joint 1315 can connect to a long edge 1212 and a short edge 1213, and can join the edges together, resulting in a formed solar module frame 1210.

In some embodiments, corner joint 1315 can be formed/fabricated through a manufacturing process such as stamping. Stamping can include taking a single plate/sheet of metal and stamping it into position (for example, using a stamping press). Stamping can include blanking, punching, piercing, bending, coining, etc. the metal sheet into a unique shape such as corner joint 1315.

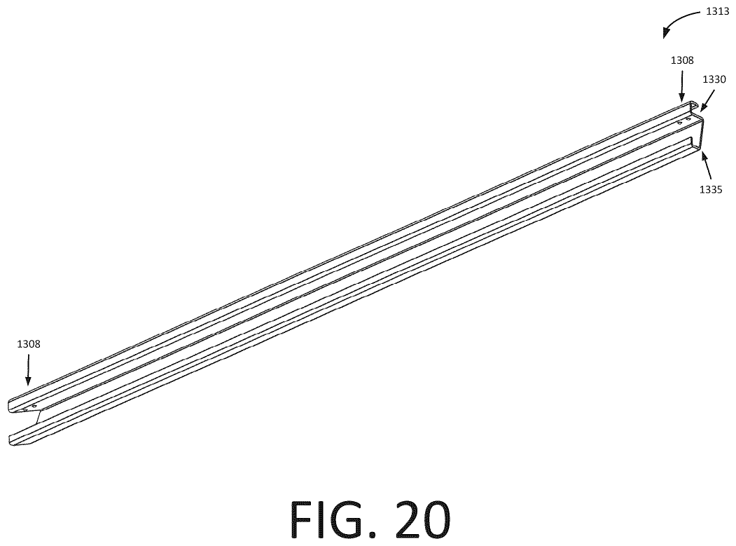

FIG. 20 illustrates an edge 1313 of a solar module frame, according to an embodiment. Although edge 1313 may be a short edge 1313, a long edge (such as long edge 1212) may have a same/similar structure and components to short edge 1313. As discussed herein, frame edges, such as short edge 1313, can include protrusions 1308. These protrusions 1308 can be small lumps/knobs that can lock into openings 1316 of the corner joint 1315. In some embodiments, as depicted in FIG. 20, an edge 1313 can include two protrusions 1308 on each side of the edge 1313.

In some embodiments, an edge (such as short edge 1313) includes a solar module receptacle 1330 portion of the edge 1313 and a base 1335 portion of the edge 1313. The solar module receptacle 1330 is the portion of the edge 1313 that holds/contains the solar module 1216. The base 1335 is the portion of the edge 1313 that provides a base and/or support for the frame 1210 and/or the solar module 1216. In some instances, the protrusions 1308 may be right below the solar module receptacle 1330.

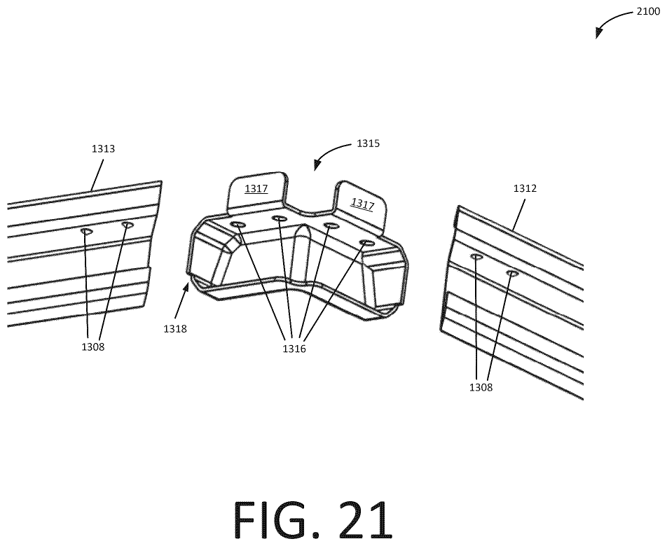

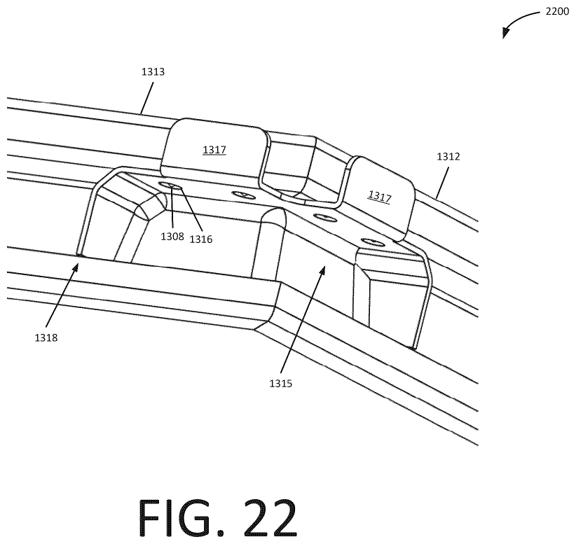

FIG. 21 illustrates a perspective view of a corner 2100 of a solar module frame prior to joining. As depicted in FIG. 21, the protrusions 1308 in each edge 1312 and 1313 line up with the openings 1316 of the corner joint. When connected, as depicted in FIG. 22 (which depicts a joined corner 2200), the protrusions 1308 can lock into the openings 1316. The stoppers 1317 and the openings 1316 can serve as locators to help guide the edges 1312 and 1313 into their proper positions in order to effectively join the edges 1312 and 1313. The frame edge recess 1318 (as depicted in FIG. 22) can rest on top of a bottom portion of the edges 1312, 1313, in some instances.

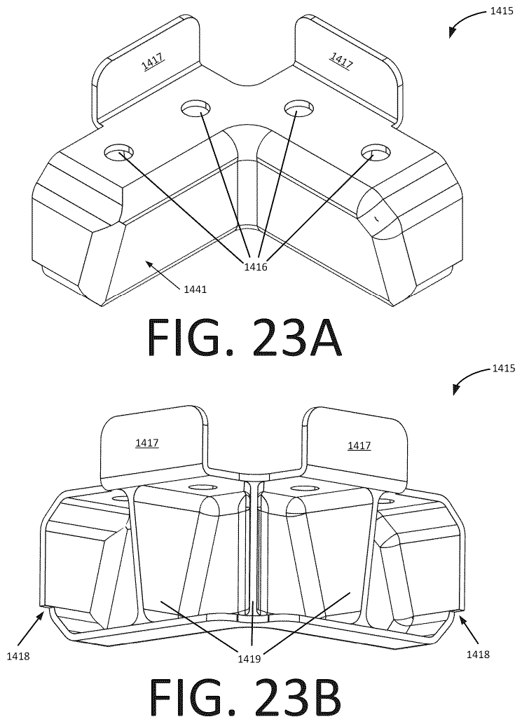

FIG. 23A-23B illustrate various perspective views of an example corner joint 1415. Corner joint 1415 is an example corner joining component used to join together edges (e.g., long edges 1212 and short edges 1213) of a solar module frame (e.g., solar module frame 1210). In some embodiments, corner joint 1415 is the same/similar as corner joint 1215 (FIGS. 17-18). Corner joint 1415 can help effectively join together/form components of a solar module frame without breaking the frame.

In some embodiments, corner joint 1415 includes openings 1416. In some instances, as discussed further herein, the edges of the solar module frame can include protrusions that lock into the openings 1416. As depicted in FIG. 19A, corner joint 1415 can include four openings 1416, in some instances. In these instances, two openings 1416 may serve as the locator/locking mechanism for a short edge of the solar module frame and two openings 1416 may serve as the locator/locking mechanism for a long edge of the solar module frame.

In some embodiments, corner joint 1415 includes stoppers 1417. In other instances, the openings 1416 alone may be effective locators/guides for the long and short edges, and corner joint 1415 may not include stoppers 1417. In some instances, as depicted in FIG. 23A, corner joint 1415 can include support 1441 in an inside portion of the corner joint 1415. Inside, as referred to herein, refers to the portions of the corner joint 1415 and/or the edges that will be in an inside/inner region of the solar module frame. Outside, as referred to herein, refers to the portions of the corner joint 1415 and/or the edges that will be in an outside/outer region of the solar module frame. These regions may be the same/similar as inside region 1340 and outside region 1350 depicted in FIG. 19C.

As depicted in FIG. 23B, corner joint 1415 can include frame edge recess 1418. In some instances, frame edge recess 1418 can be in an outside region of the corner joint 1415. In some embodiments, corner joint 1415 includes ribs 1419. Ribs 1419 can add additional support and/or reinforcement to the corner joint 1415, thus helping increase the strength and effectiveness of the corner joint 1415 within the solar module frame and the solar module assembly.

In some embodiments, although not depicted, corner joint 1415 can join together a short edge and a long edge in a same and/or similar way as depicted in FIGS. 21 and 22. For example, the protrusions 1308 of the long edge 1312 and the short edge 1313 may lock into the openings 1416 of the corner joint 1415.

In some embodiments, corner joint 1415 can be formed/fabricated through a manufacturing process such as casting. Casting can include using a mold and pouring liquid metal into the mold in order to form the corner joint 1415.

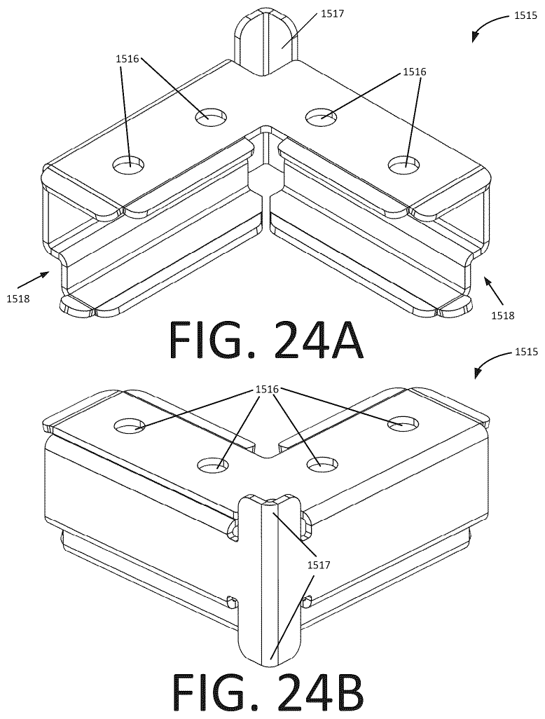

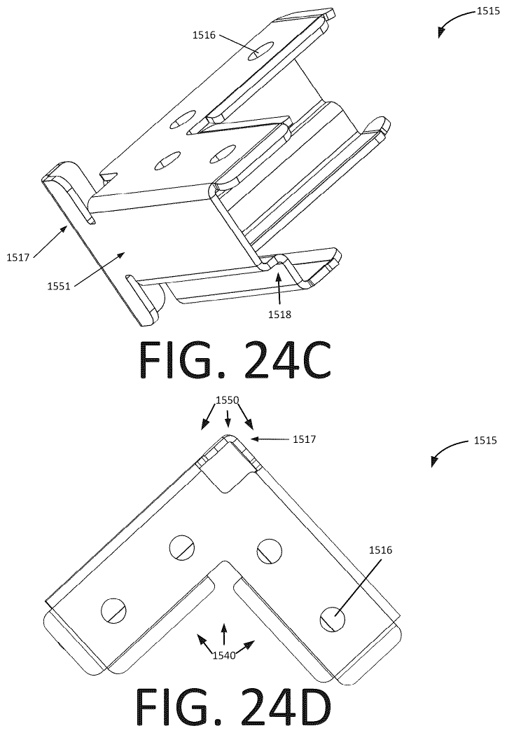

FIG. 24A-24D illustrate various perspective views of an example corner joint 1515. Corner joint 1515 is an example corner joining component used to join together edges (e.g., long edges 1212 and short edges 1213) of a solar module frame (e.g., solar module frame 1210). In some embodiments, corner joint 1515 is the same/similar as corner joint 1215 (FIGS. 17-18). Corner joint 1515 can help effectively join together/form components of a solar module frame without breaking the frame.

In some embodiments, corner joint 1515 includes openings 1516. In some instances, as discussed further herein, the edges of the solar module frame can include protrusions that lock into the openings 1516. As depicted in FIG. 24A, corner joint 1515 can include four openings 1516, in some instances. In these instances, two openings 1516 may serve as the locator/locking mechanism for a short edge of the solar module frame and two openings 1516 may serve as the locator/locking mechanism for a long edge of the solar module frame.

In some embodiments, corner joint 1515 includes stopper 1517. Stopper 1517 can extend from a top and bottom surface of the corner joint 1515 and can help position/guide the frame edges 1512, 1513 and stop them from moving beyond the corner joint 1515.

In some instances, as depicted in FIG. 24C, corner joint 1515 can include support 1551 in an outside portion of the corner joint 1515. Outside, as referred to herein, refers to the portions of the corner joint 1515 and/or the edges that will be in an outside/outer region of the solar module frame. Inside, as referred to herein, refers to the portions of the corner joint 1515 and/or the edges that will be in an inside/inner region of the solar module frame. FIG. 24D depicts the inside region 1540 of the corner joint 1515 and the outside region 1550 of the corner joint 1515. The support 1551 of corner joint 1515 may be in an outside region 1550 and stopper 1517 may also be in an outside region 1550 of the corner joint 1515, in some instances.

As depicted in FIG. 24A, corner joint 1515 can include frame edge recess 1518. In some instances, frame edge recess 1518 can be in an outside region 1550 of the corner joint 1515.

In some embodiments, a solar module frame can include four corner joints 1515 (for example, the same/similar as what is depicted in FIG. 17). Each corner joint 1515 can connect to a long edge 1212 and a short edge 1213, and can join the edges together, resulting in a formed solar module frame 1210.

In some embodiments, corner joint 1515 can be formed/fabricated through a manufacturing process such as forming (also referred to as sheet metal forming). Forming can include taking a single piece of sheet metal and bending, cutting, shaping, etc. the piece of sheet metal into a unique shape such as corner joint 1515.

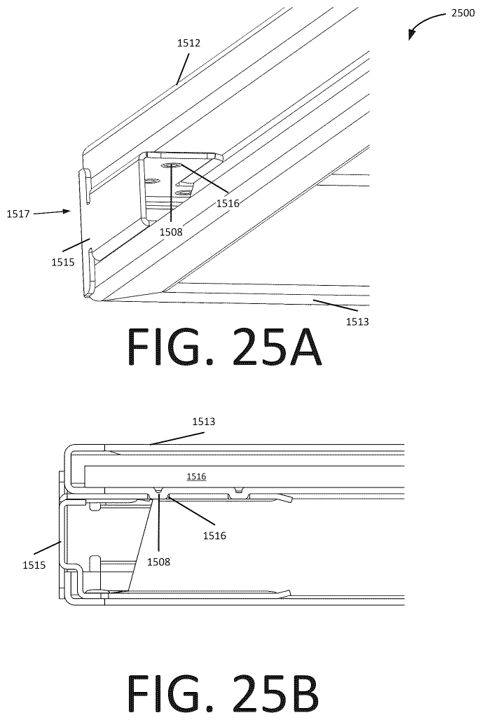

FIG. 25A illustrates a joined corner 2500 of a solar module frame. As depicted in FIG. 25A, the protrusions 1508 in each edge 1512 and 1513 line up with the openings 1516 of the corner joint 1515. When connected, the protrusions 1508 can lock into the openings 1516. The stopper 1517 and the openings 1516 can serve as locators to help guide the edges 1512 and 1513 into their proper positions in order to effectively join the edges 1512 and 1513. This can help prevent unnecessary force from being used to form the frame, thus helping prevent breakage. FIG. 25B illustrates a cross-section of the joined corner of FIG. 25A. FIG. 25B illustrates how the solar module 1516 can fit in the solar module frame and the edge 1513.

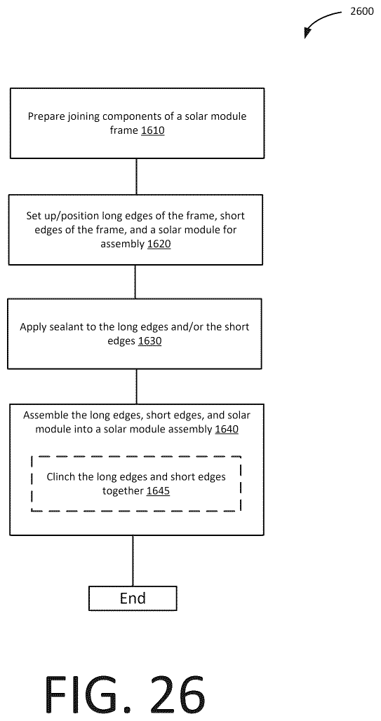

FIG. 26 illustrates an exemplary method 2600 of assembling a solar module assembly with corner joining components. In some embodiments, as discussed herein, corner joining components can include corner tabs (such as the tabs discussed herein in reference to FIGS. 2-16) and/or corner joints (such as the corner joints discussed herein in reference to FIGS. 17-25B). In some embodiments, method 2600 can be executed by one or more machines (for example, robotic arms and/or other applicable machines). These machines can, in some instances, be in a factory such as an installation factory. In some embodiments, method 2600 is an automated process.

Method 2600 can include operation 1610 to prepare the joining components of a solar module frame. In some embodiments, operation 1610 results in at least one of the long edges and the short edges comprising the joining components. As discussed herein, the joining components can include corner tabs and/or corner joints. In instances where the joining components include corner tabs, the edges (i.e., long edges or short edges) can already include the corner tabs prior to method 2600, as the edges may have been manufactured to include the corner tabs. However, in some instances, the tabs may be straight and may not be in a proper position for joining/assembling. Therefore, in some instances, preparing the joining components (operation 1610) can include bending the corner tabs. This can also be referred to herein as pre-bending the corner tabs, as the corner tabs are bent before the final assembling and/or joining (for example, as occurs in operation 1640).

In some embodiments, the joining components are corner joints. In these instances, as discussed herein, the corner joints may be a separate component than the long edges and the short edges. Therefore, in some instances, preparing the joining components (operation 1610) can include joining one or more edges (i.e., long edges and/or short edges) with the corner joints. In some instances, the corner joints are joined with the short edges (e.g., a corner joint is connected to each end of each short edge of the solar module frame). This may be referred to as pre-joining, as the corner joints and the short edges are joined prior to the final assembling and/or joining (for example, as occurs in operation 1640). In some embodiments, the corner joints are not connected to the long edges of the solar module frame until the assembling in operation 1640. In some embodiments, the corner joints are joined with/connected to the short edges the same/similar as what is depicted in FIGS. 21-22 and/or FIGS. 25A-25B .

Method 2600 can include operation 1620 to set up the long edges of the frame, short edges of the frame, and a solar module for assembly. In some embodiments, the machine(s) may place the various components (e.g., long edges, short edges, and solar module) of the solar module assembly into various placements/positions prior to assembly. For example, the machine(s) may stack the edges, pick up the edges, rotate the edges, etc. The machine(s) can also place the solar module and/or hold the solar module into a placement/position. In some embodiments, the long edges and/or short edges can already include joining components, therefore when the long edges and/or short edges are being positioned/placed, the joining components may be placed too along with their corresponding edge. In some embodiments, setting up the long edges of the frame and short edges of the frame can include positioning the long and short edges such that the solar module receptacle portions of the edges are facing upwards. This can prepare the edges for the sealant application of operation 1630.

Method 2600 can include operation 1630 to apply sealant to the long edges and/or the short edges. In some embodiments, sealant and/or adhesive is used to help attach the solar module to the solar module frame and its corresponding edges (e.g., long edges and short edges). Therefore, prior to assembling the solar module assembly, sealant can be applied to the long edges and/or the short edges. In some embodiments, sealant can be applied to the long edges and the short edges. In some embodiments, sealant can be applied to either the long edges or the short edges. Applying sealant can include piping sealant into the solar module receptacle portions of the long edges and/or short edges. In some instances, applying sealant can include dipping at least the solar module receptacle portions of the long and/or short edges into sealant.

In some instances, as discussed herein, one or more edges can be a lipless edge (such as lipless edge 913). In these instances, operation 1630 can include applying adhesive (e.g., double sided adhesive tape). In some instances, if the adhesive is pre-applied, operation 1630 can include only applying sealant to the edges that include a lip in the solar module receptacle region of the edge(s).

Method 2600 can include operation 1640 to assemble the long edges, short edges, and the solar module into a solar module assembly. In some embodiments, this can include positioning/placing the components (e.g., the long edges, short edges, and the solar module), joining together the long edges and short edges (for example, using the joining components), and securing the solar module 1216 to the solar module frame (e.g., including the long edges and the short edges) using the sealant and/or adhesive.

In some embodiments, when the joining components are corner tabs, the assembling (for example, joining together the long edges and the short edges using the joining components) can include operation 1645 to clinch the long edges and the short edges together. In instances where the long edges include tabs, the tabs of the long edges can be clinched to the short edges. In instances where the short edges include tabs, the tabs of the short edges can be clinched to the long edges.

In some embodiments, when the joining components are corner joints, the assembling (for example, joining together the long edges and the short edges using the joining components) can include joining the corner joint with the long edges. As discussed herein, the short edges may have been pre-joined to the corner joints in operation 1610. Therefore the short edges may already comprise the corner joints and the corner joints can be joined to the long edges in order to form the solar module frame. The corner joints can be joined to the long edges in a same/similar method that they are joined to the short edges.

In some embodiments, prior to clinching the long and short edges together and/or joining the corner joints and the long edges together, the assembling can include positioning/placing the components into positions the same as or similar to what is depicted in FIG. 3 and/or FIG. 18. In some instances, when the joining components are corner joints, the components can be positioned similar to the solar module assembly components 1200 in FIG. 18, however the corner joints 1215 may already be joined with the short edges 1213 as discussed in relation to operation 1610.

Advantages of embodiments disclosed herein include facilitating effective frames (e.g., maintaining strength and durability) that can be more cost effective; frames with a stronger connection/joining between edges of the frame; frames that utilize material(s) that can reduce the carbon footprint (compared to conventional materials such as aluminum); frame pieces that can effectively be joined at the corners of the frame with minimal and/or no additional hardware; more tailored/customizable frames with different edge geometries in the same frame; and/or frames with a lower cost and/or less material.

Thus, embodiments of a solar module assembly and a solar module frame with joining components (such as corner tabs and/or corner joints) are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention.

What is claimed is:

1. A solar module assembly comprising:
a solar module;
short edges;
long edges; and
corner tabs, wherein at least one of the short edges and the long edges comprise the corner tabs.

2. The solar module assembly of claim 1, wherein:
the long edges comprise the corner tabs; and
the corner tabs of the long edges are clinched to the short edges.

3. The solar module assembly of claim 1, wherein:
the short edges comprise the corner tabs; and
the corner tabs of the short edges are clinched to the long edges.

4. The solar module assembly of claim 1, wherein the short edges, the long edges, and the corner tabs are steel.

5. The solar module assembly of claim 1, wherein the short edges and the long edges have different edge types.

6. The solar module assembly of claim 1, wherein the corner tabs are sidewall tabs with sidewall clinching points.

7. The solar module assembly of claim 1, wherein the corner tabs are bottom tabs with bottom clinching points.

8. A solar module assembly comprising:
a solar module;
short edges comprising a first plurality of protrusions;
long edges comprising a second plurality of protrusions; and
corner joints comprising a plurality of openings, wherein the plurality of openings lock with the first plurality of protrusions and the second plurality of protrusions.

9. The solar module assembly of claim 8, wherein the corner joints are formed by stamping.

10. The solar module assembly of claim 8, wherein the corner joints comprise support in an inside region of the corner joints.

11. The solar module assembly of claim 8, wherein the corner joints are formed by casting.

12. The solar module assembly of claim 11, wherein the corner joints further comprise ribs.

13. The solar module assembly of claim 8, wherein the corner joints are formed by metal forming.

14. The solar module assembly of claim 13, wherein the corner joints comprise support in an outside region of the corner joints.

15. A method of forming a solar module assembly, the method comprising:
preparing joining components of a solar module frame, resulting in one or more of long edges and short edges comprising the joining components, wherein the joining components comprise at least one of corner tabs and corner joints;
positioning the long edges, the short edges, and a solar module for assembly;
applying sealant to one or more of the long edges and the short edges;
assembling the long edges, the short edges, and the solar module into the solar module assembly.

16. The method of claim 15, wherein:
the joining components are corner tabs; and
preparing the joining components comprises bending the corner tabs.

17. The method of claim 16, wherein assembling the long edges, the short edges, and the solar module into the solar module assembly comprises:
clinching the long edges and the short edges together.

18. The method of claim 16, wherein:
the short edges are lipless edges; and
applying sealant to one or more of the long edges and the short edges comprises applying sealant to the long edges and applying double sided adhesive tape to the short edges.

19. The method of claim 15, wherein:
the joining components are corner joints; and
preparing the joining components comprises joining the short edges with the corner joints.

20. The method of claim 15, wherein assembling the long edges, the short edges, and the solar module into the solar module assembly comprises:
joining the long edges with the corner joints.
